(19) United States
(12) Patent Application Publication
(10) Pub. No.: US 2025/0073738 A1
(43) Pub. Date: Mar. 6, 2025

(54) BEAUTY COMPONENT ATOMIZER

(71) Applicant: Panasonic Intellectual Property Management Co., Ltd., Osaka (JP)

(72) Inventors: MIEI KINOSHITA, Shiga (JP); AYA ISHIHARA, Osaka (JP); HIROYUKI INOUE, Shiga (JP)

(21) Appl. No.: 18/725,865

(22) PCT Filed: Nov. 30, 2022
(86) PCT No.: PCT/JP2022/044282

§ 371 Date: Jul. 1, 2024

(30) Foreign Application Priority Data
Feb. 1, 2022 (JP) 2022-014223

(51) Int. Cl. B05B 17/00; A45D 20/12; A45D 40/26

(52) U.S. Cl. CPC B05B 17/00; A45D 20/12; A45D 40/26

(57) ABSTRACT

The present disclosure provides a beauty component atomizer capable of stabilizing a spray amount of a beauty component. A beauty component atomizer according to the present disclosure is beauty component atomizer including component solid part containing at least one kind of beauty component that is solid or quasi-solid at a normal temperature, contactor which is heatable, driver connected to at least one selected from the group consisting of component solid part and contactor and configured to change a physical distance between component solid part and contactor, and controller electrically connected to contactor and driver to control a temperature of contactor and an operation of driver. Controller sets the temperature of contactor to be more than or equal to a melting point or sublimation point of the beauty component, and operates driver to change a contact state between component solid part and contactor while continuously bringing component solid part and contactor into contact with each other, and atomizes the beauty component.

### TECHNICAL FIELD

The present disclosure relates to a beauty component atomizer.

### BACKGROUND ART

PTL 1 discloses a beauty component atomizer that includes an atomizing device that applies droplets to an airflow, and a beauty component holding member that discharges a beauty component held thereby to the airflow by using the droplets contained in the airflow as a medium. In the beauty component atomizer, moisture contained in air is condensed by the atomizing device, and droplets are applied to the airflow. The droplets applied to the airflow pass through the beauty component holding member, and thereby the held beauty component is dissolved into the droplet. The droplets in which the beauty component has been dissolved are ejected together with the airflow from an ejector.

### CITATION LIST

### Patent Literature

PTL 1: Unexamined Japanese Patent Publication No. 2019-111158

### SUMMARY OF THE INVENTION

### Technical Problem

Incidentally, in the beauty component atomizer described in PTL 1, since the beauty component held by the beauty component holding member is dissolved into the droplets, a spray amount of the beauty component is large at the beginning of use, but the spray amount of the beauty component decreases when the beauty component continues to use. Thus, it is impossible to control the spray amount of the beauty component, and the spray amount of the beauty component was not stable.

The present disclosure has been made in view of such a problem of the technique of the related art. An object of the present disclosure is to provide a beauty component atomizer capable of stabilizing a spray amount of a beauty component.

### Solution to Problem

A beauty component atomizer according to an aspect of the present disclosure includes a component solid part that contains at least one beauty component that is solid or quasi-solid at a normal temperature, a contactor which is heatable, a driver that is connected to at least one selected from the group consisting of the component solid part and the contact part, and is configured to change a physical distance between the component solid part and the contact part, and a controller that is electrically connected to the contactor and the driver to control a temperature of the contactor and an operation of the driver. The controller sets the temperature of the contactor to be more than or equal to a melting point or sublimation point of the beauty component, and operates the driver to change a contact state between the component solid part and the contactor while continuously bringing the component solid part and the contactor into contact with each other, and atomizes the beauty component.

### Advantageous Effect of Invention

According to the present disclosure, it is possible to provide the beauty component atomizer capable of stabilizing the spray amount of the beauty component.

### BRIEF DESCRIPTION OF THE DRAWINGS

FIG. 1 is a cross-sectional view of a beauty component atomizer according to the present exemplary embodiment.

FIG. 2 is a side view of a component solid part, a holder, a driver, and a contactor of the beauty component atomizer according to the present exemplary embodiment.

FIG. 3 is a side view when the component solid part is accommodated in the holder from the state illustrated in FIG. 2.

FIG. 4 is a side view of the component solid part, the holder, the driver, the contactor, an elastic member, a heater, a thermocouple, and a force detector of the beauty component atomizer according to the present exemplary embodiment.

FIG. 5 is a schematic view illustrating an electrical connection between a controller and each mechanism of the beauty component atomizer according to the present exemplary embodiment.

FIG. 6 is a schematic view illustrating an example of a state change with respect to an extrusion speed between the component solid part and the contactor of the beauty component atomizer according to the present exemplary embodiment.

FIG. 7 is a schematic view illustrating another example of the state change with respect to the extrusion speed between the component solid part and the contactor of the beauty component atomizer according to the present exemplary embodiment.

FIG. 8 is a graph representing a change in atomization amount of a beauty component with respect to the extrusion speed in FIGS. 6 and 7.

FIG. 9 is a schematic view illustrating an example of a state change with respect to a pressing force between the component solid part and the contactor of the beauty component atomizer according to the present exemplary embodiment.

FIG. 10 is a schematic view illustrating another example of the state change with respect to the pressing force between the component solid part and the contactor of the beauty component atomizer according to the present exemplary embodiment.

FIG. 11 is a graph representing a change in atomization amount of the beauty component with respect to time in FIGS. 9 and 10.

FIG. 12 is a schematic view illustrating an example of the state change with respect to the pressing force between the component solid part and the contactor of the beauty component atomizer according to the present exemplary embodiment.

FIG. 13 is a graph representing a change in distance between the component solid part and the contactor with respect to time in FIG. 12.

FIG. 14 is a graph representing the change in atomization amount of the beauty component with respect to time in FIG. 12.

FIG. 15 is a schematic view illustrating another example of the state change with respect to the pressing force between the component solid part and the contactor of the beauty component atomizer according to the present exemplary embodiment.

FIG. 16 is a graph representing the change in distance between the component solid part and the contactor with respect to time in FIG. 15.

FIG. 17 is a graph representing the change in atomization amount of the beauty component with respect to time in FIG. 15.

FIG. 18 is a graph representing the change in atomization amount of the beauty component with respect to time.

FIG. 19 is a graph representing a change in pressing force between the component solid part and the contactor with respect to time in FIG. 18.

FIG. 20 is a graph representing the change in atomization amount of the beauty component with respect to time.

FIG. 21 is a graph representing the change in pressing force between the component solid part and the contactor with respect to time in FIG. 20.

FIG. 22 is a graph representing a change in atomization amount with respect to a temperature of beauty component A.

FIG. 23 is a graph representing a change in temperature of the contactor with respect to time in FIG. 18.

FIG. 24 is a graph representing a change in temperature of the contactor with respect to time in FIG. 20.

FIG. 25 is a graph representing a timing at which an air blower in FIG. 24 blows warm air.

FIG. 26 is a graph representing the change in atomization amount of the beauty component with respect to time.

FIG. 27 is a graph representing a change in temperature of the contactor with respect to time in FIG. 26.

FIG. 28 is a front view when the component solid part of the beauty component atomizer according to the present exemplary embodiment contains a plurality of kinds of beauty components.

FIG. 29 is a side view when the component solid part rotates from the state of FIG. 28.

FIG. 30 is a side view when the component solid part rotates from the state of FIG. 29.

FIG. 31 is a graph representing a change in ratio of beauty component A in an atomized beauty component to a rotation angle of the component solid part illustrated in FIGS. 28 to 30.

FIG. 32 is a front view illustrating an example of disposition of beauty components when the component solid part of the beauty component atomizer according to the present exemplary embodiment contains the plurality of kinds of beauty components.

FIG. 33 is a front view illustrating another example of the disposition of the beauty components when the component solid part of the beauty component atomizer according to the present exemplary embodiment contains the plurality of kinds of beauty components.

FIG. 34 is a graph representing a change in atomization amount of beauty component B with respect to a temperature.

FIG. 35 is a graph representing changes in atomization amount of beauty component A and beauty component B with respect to a temperature.

FIG. 36 is a cross-sectional view when the beauty component atomizer according to the present exemplary embodiment includes an atomization amount detector.

FIG. 37 is a graph representing another change in atomization amount with respect to the temperature of beauty component A.

### DESCRIPTION OF EMBODIMENT

Hereinafter, an exemplary embodiment will be described in detail with reference to the drawings. However, unnecessarily detailed description may be omitted. For example, a detailed description of already well-known matters or a redundant description of substantially the same configuration may be omitted.

Note that, the attached drawings and the following description are provided for those skilled in the art to fully understand the present disclosure, and are not intended to limit the subject matter as described in the appended claims.

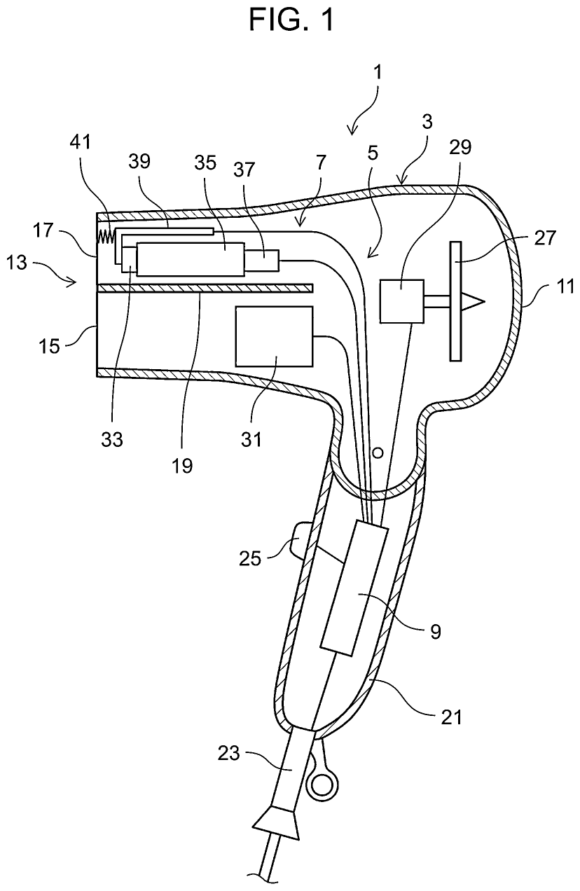

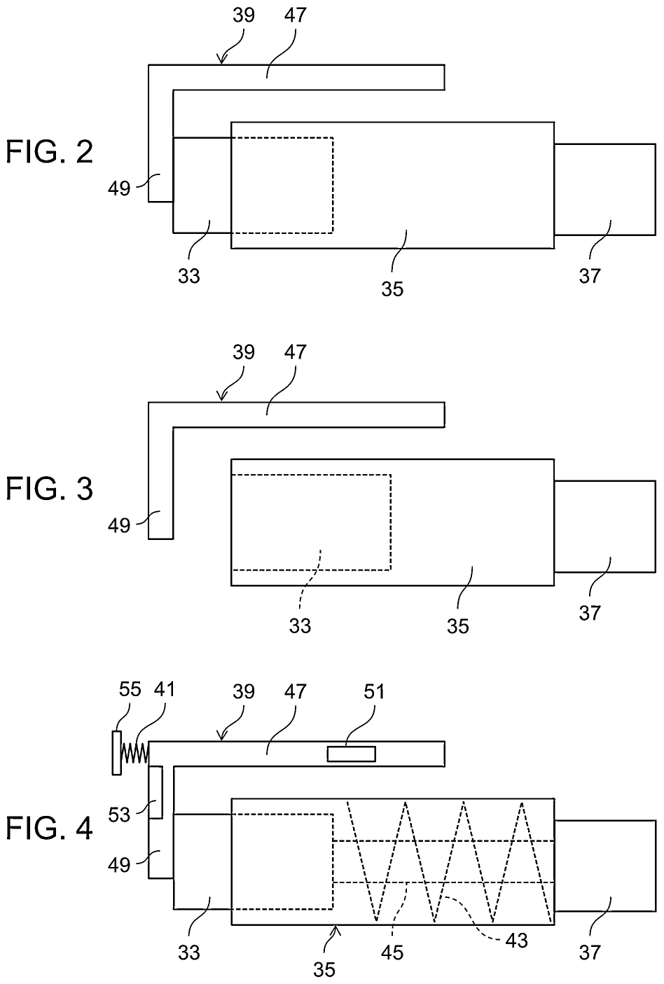

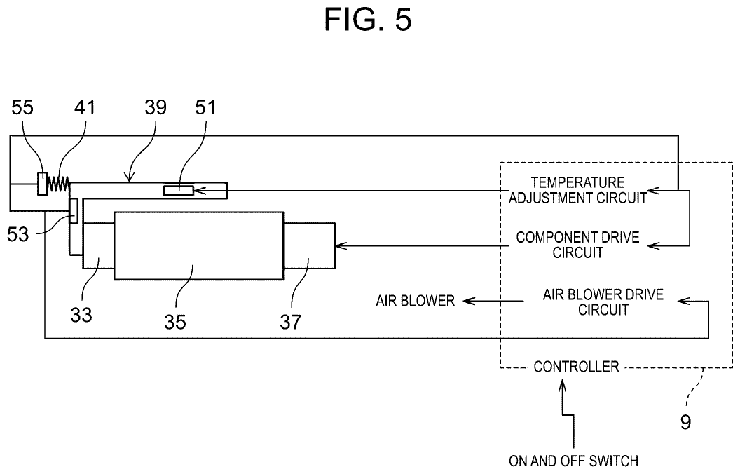

FIG. 1 is a cross-sectional view 1 of a beauty component atomizer according to the present exemplary embodiment. FIG. 2 is a side view of component solid part 33, holder 35, driver 37, and contactor 39 of beauty component atomizer 1 according to the present exemplary embodiment. FIG. 3 is a side view when component solid part 33 is accommodated in holder 35 from the state illustrated in FIG. 2. FIG. 4 is a side view of component solid part 33, holder 35, driver 37, contactor 39, elastic member 41, heater 51, thermocouple 53, and force detector 55 of beauty component atomizer 1 according to the present exemplary embodiment. FIG. 5 is a schematic view illustrating an electrical connection between controller 9 and each mechanism of beauty component atomizer 1 according to the present exemplary embodiment. As illustrated in FIGS. 1 to 5, beauty component atomizer 1 according to the present exemplary embodiment is applied to, for example, a hair dryer. Beauty component atomizer 1 includes housing 3, air blower 5, atomizer 7, and controller 9.

As illustrated in FIG. 1, housing 3 is formed in a housing shape capable of accommodating air blower 5, atomizer 7, and controller 9 therein. Suction port 11 through which external air is taken in, and ejector 13 through which an airflow adjusted inside is blown out are provided in housing 3. Ejector 13 has ejection port 15 that blows out a large amount of airflow and component ejection port 17 that blows out an atomized beauty component together with the airflow. Ejection port 15 and component ejection port 17 are partitioned by partition wall 19.

Grip 21 to be gripped by a user is provided in housing 3. Power supply unit 23 to which power is supplied from a power supply is provided at an end portion of grip 21. Switch 25 for selecting whether or not to eject the beauty component from ejector 13 is provided on an outer surface of grip 21. Note that, although not illustrated, a power switch for turning on and off the supply of power from the power supply is provided on the outer surface of grip 21.

As illustrated in FIG. 1, air blower 5 includes fan 27, fan motor 29, and air blower heater 31. Fan 27 is disposed between suction port 11 and ejector 13. Fan 27 rotates to take in external air from suction port 11 and eject an airflow from ejector 13. Fan motor 29 is connected to fan 27 and operates to rotate fan 27. Air blower heater 31 is disposed between fan 27 and ejector 13. Air blower heater 31 heats the airflow to set the airflow as warm air, and ejects the warm air from ejector 13.

As illustrated in FIGS. 1 to 5, atomizer 7 includes component solid part 33, holder 35, driver 37, contactor 39, and elastic member 41.

Component solid part 33 is formed in a columnar shape. Component solid part 33 contains at least one kind of beauty component that is solid or quasi-solid at a normal temperature. Note that, the normal temperature is 25° C.

Examples of the beauty component include collagen, elastin, and keratin as proteins, and various peptides as peptides. In addition, examples of the beauty component include lysine, phenylalanine, arginine, and cysteine as amino acids, and various ceramides as ceramides. Further, examples of the beauty component include succinic acid, maleic acid, fumaric acid, lactic acid, malic acid, tartaric acid, citric acid, and sebacic acid as organic acids, and various vitamins as vitamins. In addition, examples of the beauty component include astaxanthin, lutein, and catechin as antioxidant components, and isoflavone, dutasteride, finasteride, and the like as hormones. Further, examples of the beauty component include lauric acid, myristic acid, palmitic acid, stearic acid, stearyl alcohol, cholesterol, petrolatum, coconut oil, and the like as lipids. In addition, examples of the beauty component include trehalose, dextrin, cyclodextrin, and maltitol as saccharides. Further, examples of the beauty component include chitin as polysaccharides, urea as other components, and glycyrrhizic acid.

Holder 35 is formed in a circular cylindrical shape capable of accommodating component solid part 33 therein. The following three solidification methods can be used.

### (Solidifying Method 1)

A cylindrical solidifying container in which both inlet ports are opened is provided, lids which enter both the opened inlet ports is provided, and a predetermined amount of beauty substance is put into the solidifying container in which lubricity is enhanced by fluororesin. A predetermined force is applied to at least one lid on a side where a pressure is applied to the beauty substance. Further, the solidifying container is heated to be more than or equal to a melting point. After a lapse of a predetermined time, one lid is removed, and the solidified beauty substance is extruded with the other lid while being hot, and then cooled at a room temperature. In a case where the beauty substance is water-soluble, it is desirable to add water having a mass ratio of about 10% to the beauty substance at the time of applying the pressure.

### (Solidifying Method 2)

The beauty substance is put into a cylindrical solidifying container having an upper opening, and the solidifying container is heated to be more than or equal to a melting point and is cooled at a room temperature after a lapse of a predetermined time.

### (Solidifying Method 3)

The beauty substance is heated to be more than or equal to a melting point, is sufficiently melted, is then poured into a cylindrical solidifying container having an upper opening, and is cooled at room temperature.

Screw 43 formed in a spiral shape and guide 45 extending along an axial direction are provided inside holder 35. Holder 35 holds component solid part 33 in a protrudable-retractable and rotatable way. Component solid part 33 held by holder 35 rotates to one side, and thus, component solid part 33 moves in an axial direction toward a direction exiting from holder 35 by screw 43 and guide 45. On the other hand, component solid part 33 rotates to the other side, and thus, component solid part 33 moves in the axial direction toward a direction of entering holder 35 by screw 43 and guide 45.

Driver 37 includes, for example, a motor rotatable in both forward and reverse directions. Driver 37 is disposed on one side of holder 35 in a length direction, and a motor shaft is connected to component solid part 33 to be rotatable integrally. Driver 37 operates to rotate component solid part 33, and causes component solid part 33 to protrude and retract in the axial direction with respect to holder 35. Note that, driver 37 may independently include, for example, a motor that rotates component solid part 33 and a rod that moves component solid part 33 in the axial direction. In this case, it is not necessary to provide screw 43 or guide 45 in holder 35, and holder 35 can have a simple structure.

Contactor 39 includes fixing part 47 and contact part 49 formed as one member continuous with fixing part 47. Fixing part 47 extends in the length direction of holder 35 and is fixed to housing 3. Heater 51 that heats contactor 39 is provided inside fixing part 47. Contact part 49 is formed in a triangular shape and is disposed to face component solid part 33. An area of contact part 49 is set to be smaller than an area of an end surface of component solid part 33. Thermocouple 53 that detects a temperature of contactor 39 is provided inside contact part 49.

Contact part 49 is brought into contact with component solid part 33 in a state where contactor 39 is heated to be more than or equal to a melting point or sublimation point of the beauty component contained in component solid part 33 by heating of heater 51. When contact part 49 comes into contact with component solid part 33, the beauty component of component solid part 33 is atomized. The atomized beauty component is mixed with the airflow and is ejected together with the airflow from component ejection port 17 of ejector 13.

Elastic member 41 is made of, for example, a stretchable spring. One end of elastic member 41 abuts on force detector 55 that detects a pressing force received from component solid part 33 fixed to housing 3, and the other end abuts on contact part 49 of contactor 39. Note that, force detector 55 also functions as a contact detector that detects contact between component solid part 33 and contactor 39. When contact part 49 abuts on component solid part 33, elastic member 41 is elastically deformed and receives the pressing force from component solid part 33. Elastic member 41 receives the pressing force from component solid part 33, and thus, variation in contact pressure between component solid part 33 and contactor 39 can be suppressed. As a result, variation in atomization amount of the beauty component can be suppressed.

As illustrated in FIGS. 1 and 5, controller 9 is electrically connected to heater 51 of contactor 39, thermocouple 53 of contactor 39, driver 37, fan motor 29, air blower heater 31, switch 25, and force detector 55. Controller 9 includes, for example, a temperature adjustment circuit, a component drive circuit, and an air blower drive circuit. Based on the temperature measured by thermocouple 53 and the pressing force measured by force detector 55, the temperature adjustment circuit adjusts the heating of heater 51, and adjusts the temperature of contactor 39. Based on the temperature measured by thermocouple 53 and the pressing force measured by force detector 55, the component drive circuit adjusts an operation of driver 37, and adjusts a contact state between component solid part 33 and contactor 39. Based on the temperature measured by thermocouple 53, the air blower drive circuit adjusts operations of fan motor 29 and air blower heater 31, and adjusts the airflow ejected from ejector 13. Note that, a timer is built in controller 9, and time can be measured.

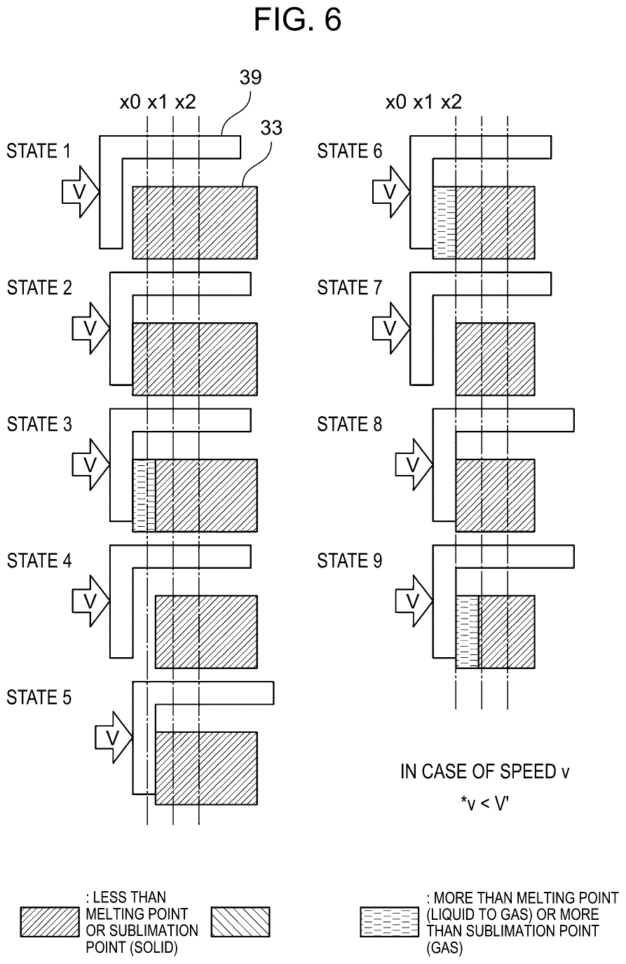

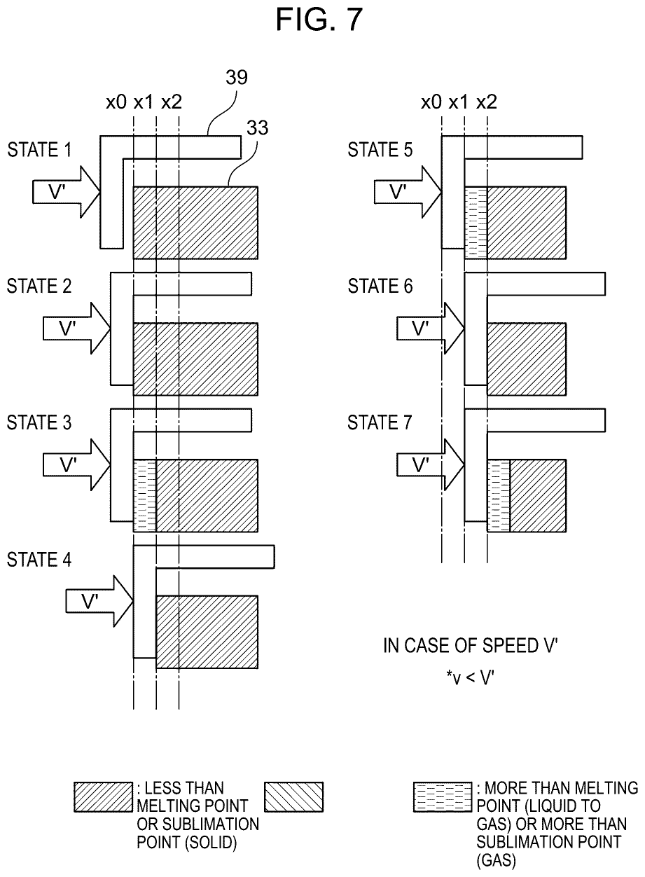

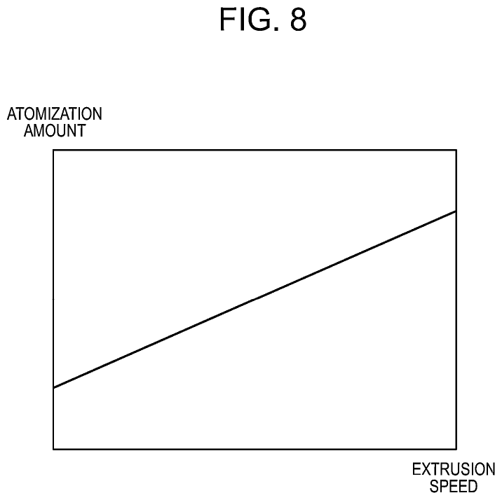

Here, in a case where the temperature of contactor 39 is more than or equal to a boiling point of the beauty component, when component solid part 33 and contactor 39 come into contact with each other, the temperature of the beauty component is immediately more than or equal to the melting point and is atomized. Note that, here, it is assumed that the temperature of contactor 39 is more than or equal to the boiling point of the beauty component and contactor 39 moves with respect to component solid part 33. FIG. 6 is a schematic view illustrating an example of a state change with respect to an extrusion speed between component solid part 33 and contactor 39 of beauty component atomizer 1 according to the present exemplary embodiment. As illustrated in FIG. 6, when a moving speed (that is, the extrusion speed) of contactor 39 with respect to component solid part 33 is slow, as shown in states 1 to 9, a chance of contact between component solid part 33 and contactor 39 per unit time is small, and the atomization amount of the beauty component becomes small. FIG. 7 is a schematic view illustrating another example of the state change with respect to the extrusion speed between component solid part 33 and contactor 39 of beauty component atomizer 1 according to the present exemplary embodiment. As illustrated in FIG. 7, when the moving speed (that is, the extrusion speed) of contactor 39 with respect to component solid part 33 is fast, as shown in states 1 to 7, the chance of contact between component solid part 33 and contactor 39 per unit time is large, and the atomization amount of the beauty component becomes large. FIG. 8 is a graph representing a change in atomization amount of the beauty component with respect to the extrusion speed in FIGS. 6 and 7. As illustrated in FIG. 8, as the extrusion speed of contactor 39 becomes fast, the atomization amount of the beauty component increases.

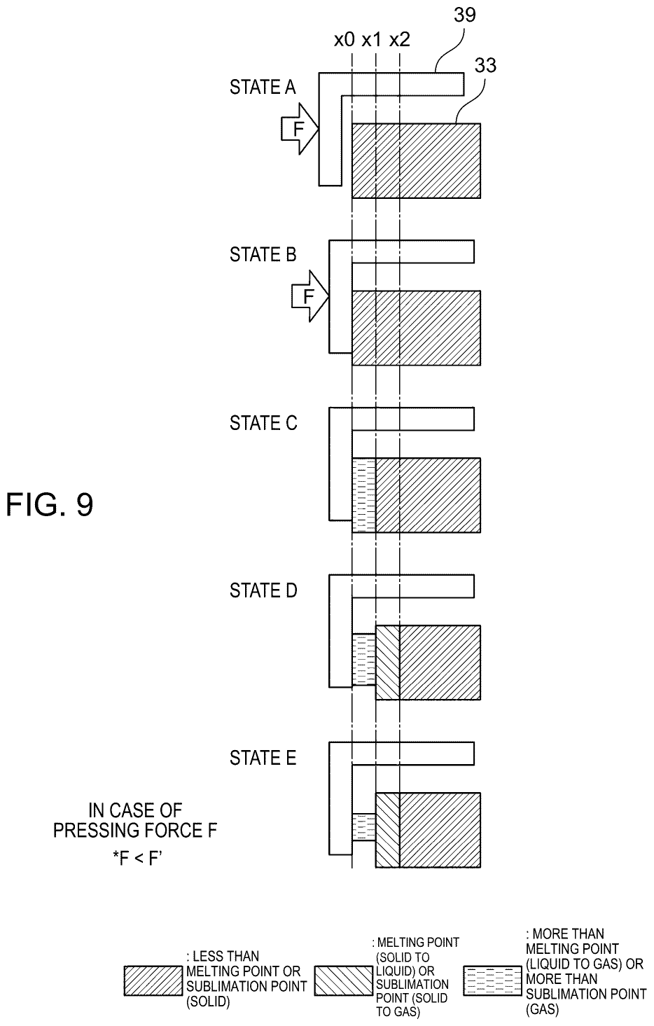

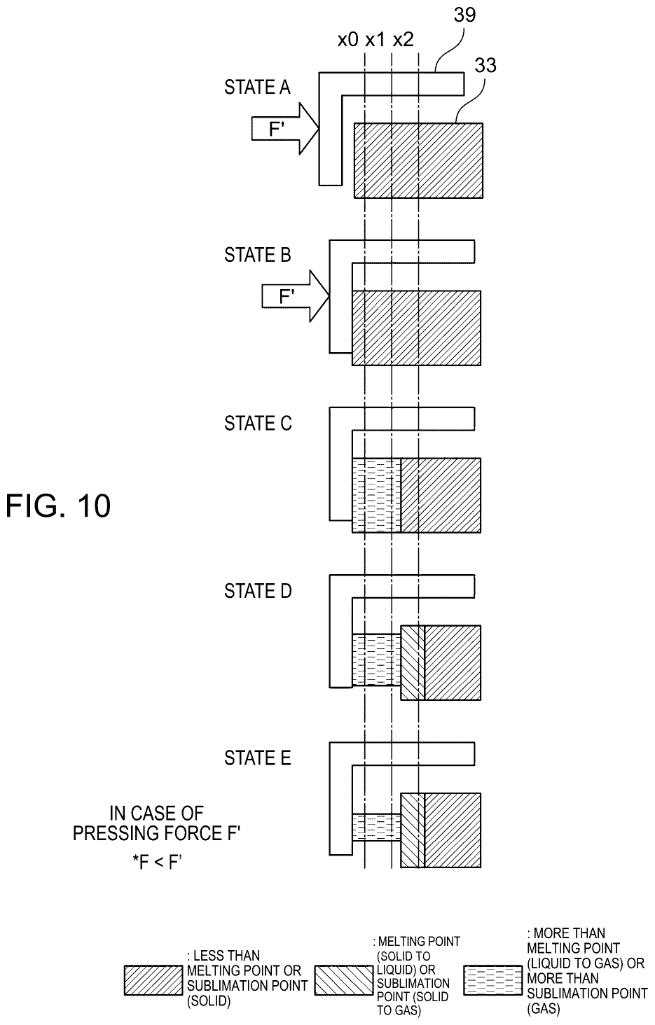

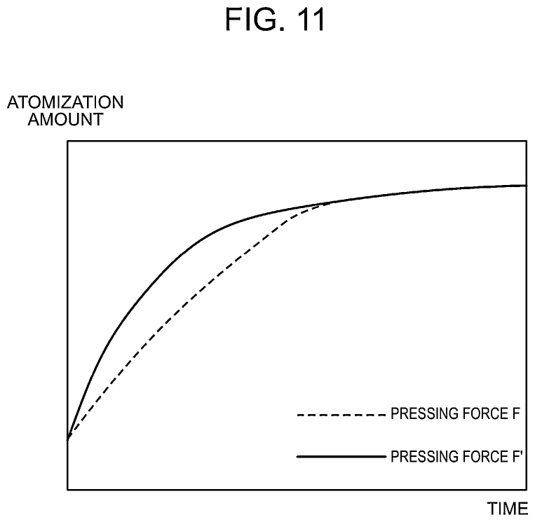

On the other hand, in a case where the temperature of contactor 39 is more than or equal to the melting point or sublimation point of the beauty component and less than or equal to the boiling point of the beauty component, when component solid part 33 and contactor 39 come into contact with each other, the temperature of the beauty component is more than or equal to the melting point after a lapse of a certain period of time until heat is transferred, and then, the beauty component is atomized. The heat transfer from contactor 39 to component solid part 33 is relevant to the pressing force. Note that, here, it is assumed that the temperature of contactor 39 is more than or equal to the melting point or sublimation point of the beauty component and less than or equal to the boiling point of the beauty component and that contactor 39 moves with respect to component solid part 33. FIG. 9 is a schematic view illustrating an example of a state change with respect to the pressing force between component solid part 33 and contactor 39 of beauty component atomizer 1 according to the present exemplary embodiment. FIG. 10 is a schematic view illustrating another example of the state change with respect to the pressing force between component solid part 33 and contactor 39 of beauty component atomizer 1 according to the present exemplary embodiment. FIG. 11 is a graph representing the change in atomization amount of the beauty component with respect to time in FIGS. 9 and 10. As illustrated in FIG. 9, when the pressing force of contactor 39 against component solid part 33 is small, as in states A to E, the heat of contactor 39 is less likely to be transferred to the beauty component, and the atomization amount of the beauty component becomes small. On the other hand, as illustrated in FIG. 10, when the pressing force of contactor 39 against component solid part 33 is large, as in states A to E, the heat of contactor 39 is likely to be transferred to the beauty component, and the atomization amount of the beauty component becomes large. Thus, as illustrated in FIG. 11, as the pressing force of contactor 39 becomes large, the atomization amount of the beauty component increases.

Therefore, as basic control, when switch 25 is turned on, controller 9 heats heater 51 of contactor 39 to set the temperature of contactor 39 to be more than or equal to the melting point or sublimation point of the beauty component. Subsequently, controller 9 operates driver 37 to bring component solid part 33 into contact with contactor 39, and to atomize the beauty component. At this time, while switch 25 is turned on, controller 9 operates driver 37 to perform control such that component solid part 33 is constantly brought into contact with contactor 39. When the atomization amount of the beauty component is changed, controller 9 controls the operation of driver 37 to change the contact state between component solid part 33 and contactor 39. The atomized beauty component is mixed with the airflow generated due to the operation of fan 27, and is ejected to an outside from component ejection port 17 of ejector 13.

As described above, controller 9 brings contactor 39 heated to be more than or equal to the melting point or sublimation point of the beauty component into contact with component solid part 33 containing the beauty component that is solid or quasi-solid at a normal temperature, and atomizes the beauty component. Thus, until the beauty component of component solid part 33 is completely atomized, the atomization amount of the beauty component does not change, and a spray amount of the beauty component can be stabilized. The spray amount of the beauty component is stabilized, and thus, for example, uneven adhesion of the beauty component adhering to hair can be prevented.

While the atomized beauty component is being ejected from component ejection port 17 of ejector 13, that is, while switch 25 is turned on, controller 9 operates driver 37 to constantly bring component solid part 33 into contact with contactor 39. Thus, when the atomized beauty component is ejected from ejector 13, the beauty component is in a state of being constantly atomized, and the atomized beauty component can be continuously ejected from ejector 13. The atomized beauty component is continuously ejected from ejector 13, and thus, for example, the uneven adhesion of the beauty component adhering to the hair can be prevented.

Controller 9 controls the operation of driver 37 to change the contact state between component solid part 33 and contactor 39. In a case where the atomization amount of the beauty component is increased, controller 9 operates driver 37 to increase the pressing force of component solid part 33 against contactor 39. In a case where the atomization amount of the beauty component is decreased, controller 9 operates driver 37 to decrease the pressing force of component solid part 33 against contactor 39. Controller 9 can adjust the atomization amount of beauty component by changing the contact state between component solid part 33 and contactor 39.

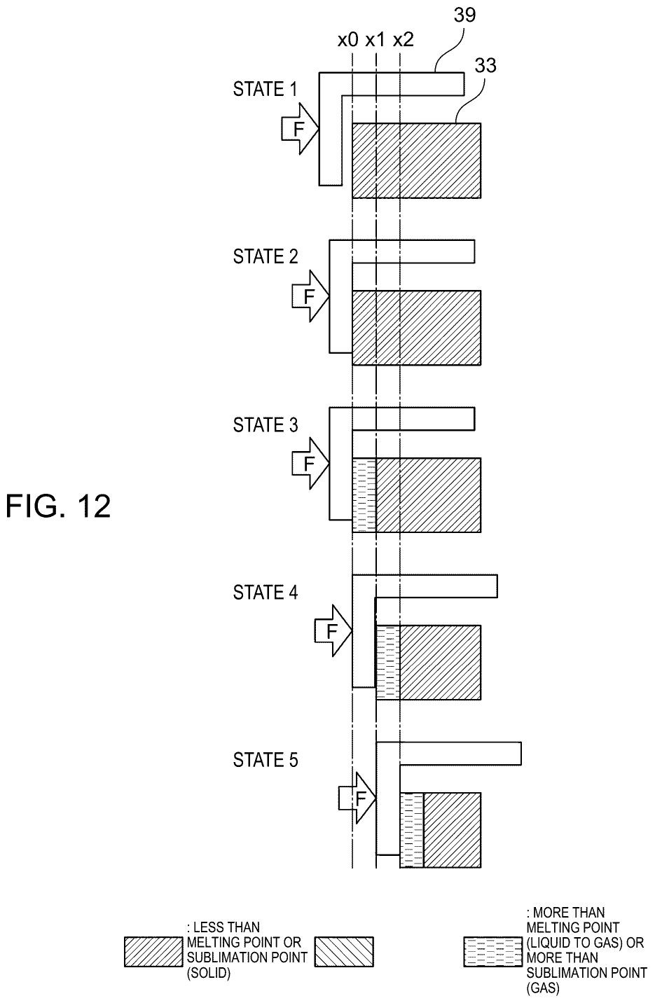

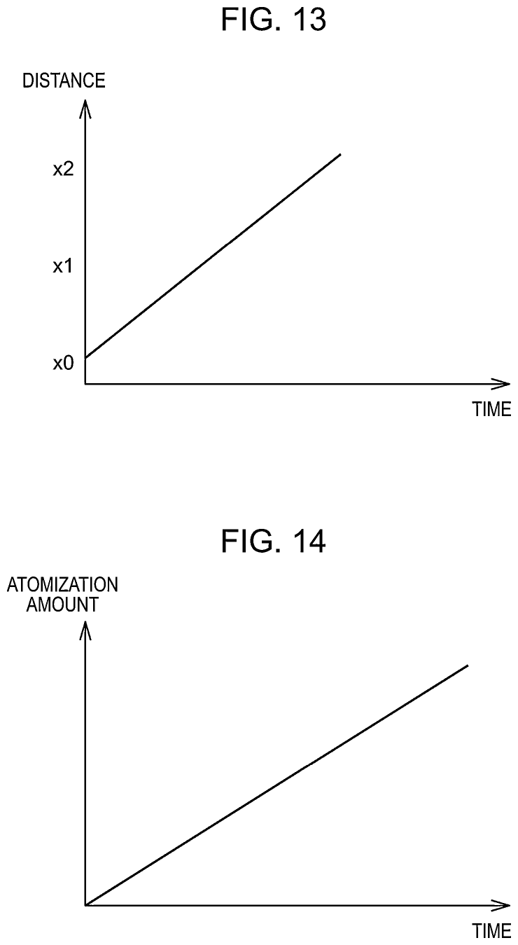

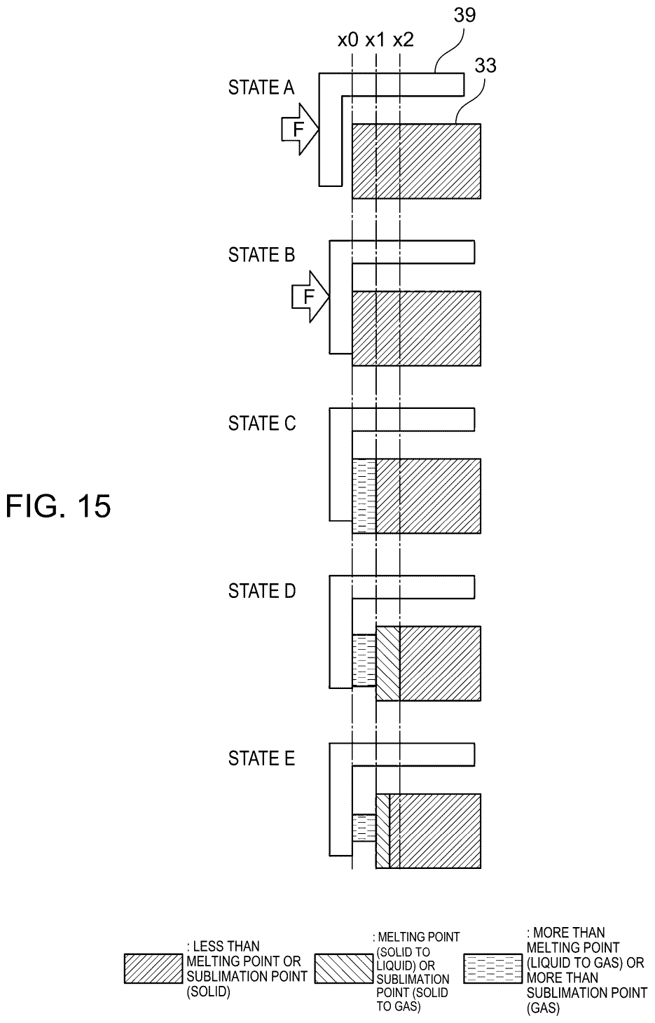

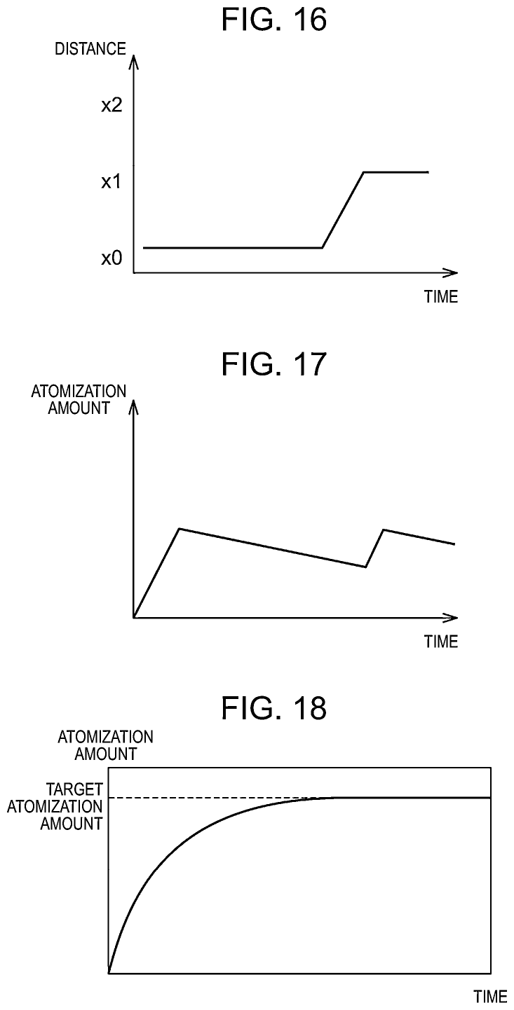

Here, there is a difference in the change in atomization amount of the beauty component between a case where the pressing force is continuously applied and a case where the pressing force is not applied in a state where component solid part 33 and contactor 39 are in contact with each other. Note that, here, it is assumed that the temperature of contactor 39 is more than or equal to the melting point or sublimation point of the beauty component and that contactor 39 moves with respect to component solid part 33. FIG. 12 is a schematic view illustrating an example of the state change with respect to the pressing force between component solid part 33 and contactor 39 of beauty component atomizer 1 according to the present exemplary embodiment. FIG. 13 is a graph representing a change in distance between component solid part 33 and contactor 39 with respect to time in FIG. 12. FIG. 14 is a graph representing the change in atomization amount of the beauty component with respect to time in FIG. 12. FIG. 15 is a schematic view illustrating another example of the state change with respect to the pressing force between component solid part 33 and contactor 39 of beauty component atomizer 1 according to the present exemplary embodiment. FIG. 16 is a graph representing the change in distance between component solid part 33 and contactor 39 with respect to time in FIG. 15. FIG. 17 is a graph representing the change in atomization amount of the beauty component with respect to time in FIG. 15. As illustrated in FIG. 12, in a case where the pressing force is continuously applied, the beauty component of component solid part 33 is continuously atomized as shown in states 1 to 5. Thus, as illustrated in FIGS. 13 and 14, the distance between component solid part 33 and contactor 39 continuously increases, and the atomization amount of the beauty component also continuously increases. On the other hand, as illustrated in FIG. 15, in a case where the pressing force is not applied, as in shown states A to E, it takes time to transfer heat from contactor 39 to component solid part 33, and the beauty component is gradually atomized. Thus, as illustrated in FIGS. 16 and 17, the distance between component solid part 33 and contactor 39 increases after a lapse of a predetermined time, and the atomization amount of the beauty component decreases after increasing to a maximum value.

In a case where the atomization amount of the beauty component is continuously increased, controller 9 controls the operation of driver 37 such that component solid part 33 continuously applies the pressing force to contactor 39. On the other hand, when the atomization amount of the beauty component is set to a predetermined amount, controller 9 controls the operation of driver 37 such that component solid part 33 applies the pressing force to contactor 39 in a predetermined time. Note that, controller 9 detects that component solid part 33 and contactor 39 come into contact with each other from force detector 55, and measures the predetermined time. The pressing force of controller 9 is controlled, and thus, the atomization amount of the beauty component can be stabilized.

Based on the pressing force measured by force detector 55, controller 9 controls the operation of driver 37 to adjust the pressing force of component solid part 33 against contactor 39 and to adjust the atomization amount of the beauty component. Controller 9 controls the operation of driver 37 based on the pressing force measured by force detector 55, and thus, an optimum atomization amount of beauty component can be ejected from ejector 13.

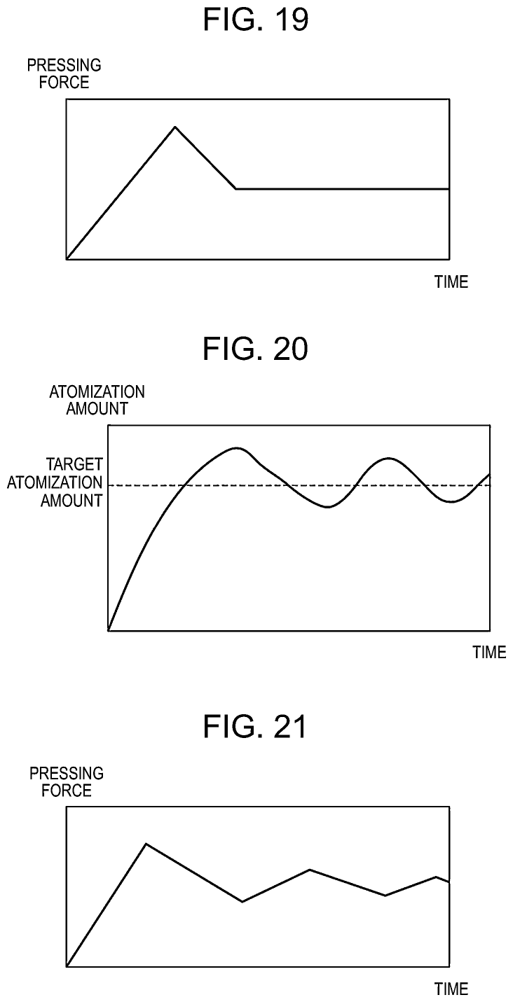

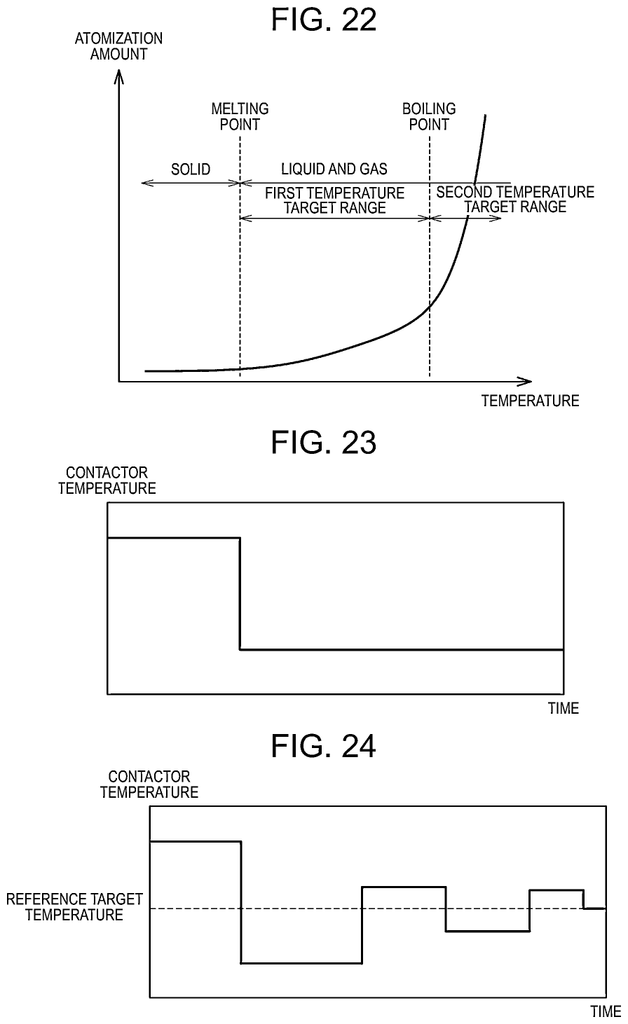

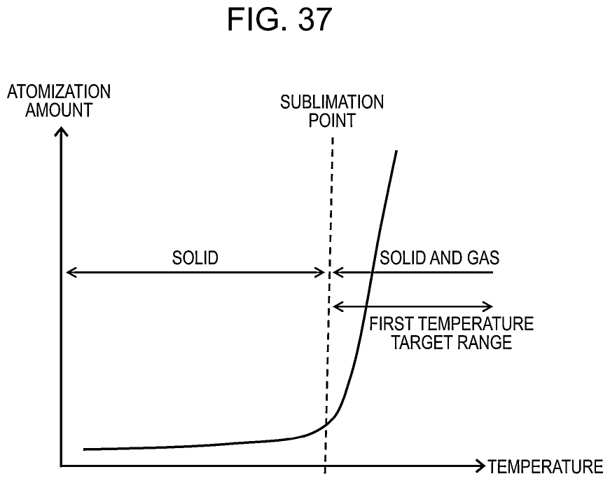

FIG. 18 is a graph representing the change in atomization amount of the beauty component with respect to time. FIG. 19 is a graph representing a change in pressing force between component solid part 33 and contactor 39 with respect to time in FIG. 18. FIG. 20 is a graph representing the change in atomization amount of the beauty component with respect to time. FIG. 21 is a graph representing the change in pressing force between component solid part 33 and contactor 39 with respect to time in FIG. 20. FIG. 22 is a graph representing a change in atomization amount of beauty component A with respect to a temperature. FIG. 37 is a graph representing another change in atomization amount of beauty component A with respect to the temperature. For example, it is assumed that the temperature of contactor 39 is more than or equal to the boiling point of the beauty component and that the atomization amount of the beauty component is changed from a target atomization amount as illustrated in FIG. 18. As illustrated in FIG. 19, based on the pressing force measured by force detector 55, controller 9 operates driver 37 to increase the pressing force until a predetermined time. After a predetermined time has elapsed, based on the pressing force measured by force detector 55, controller 9 operates driver 37 to decrease the pressing force and to hold the pressing force with a predetermined pressing force.

For example, it is assumed that the temperature of contactor 39 is more than or equal to the boiling point of the beauty component and that the atomization amount of the beauty component is changed from the target atomization amount as illustrated in FIG. 20. As illustrated in FIG. 21, based on the pressing force measured by force detector 55, controller 9 operates driver 37 to increase the pressing force until a predetermined time. Subsequently, after a predetermined time has elapsed, based on the pressing force measured by force detector 55, controller 9 operates driver 37 to decrease the pressing force until a predetermined time. Subsequently, after a predetermined time has elapsed, based on the pressing force measured by force detector 55, controller 9 operates driver 37 to increase the pressing force until a predetermined time. Subsequently, after a predetermined time has elapsed, based on the pressing force measured by force detector 55, controller 9 operates driver 37 to decrease the pressing force until a predetermined time. After a predetermined time has elapsed, based on the pressing force measured by force detector 55, controller 9 operates driver 37 to increase the pressing force until a predetermined time.

Here, as illustrated in FIG. 22, for example, the beauty component changes from a solid to a liquid at a melting point, and changes from the liquid to a gas and is atomized at a boiling point. As illustrated in FIG. 37, for example, when the beauty component changes from the solid to the gas and is atomized at a sublimation point. Thus, the beauty component is atomized at a temperature more than or equal to the melting point or sublimation point. The atomization amount of the beauty component gently increases as the temperature rises in a range of more than or equal to the melting point or sublimation point of the beauty component and less than or equal to the boiling point of the beauty component. The atomization amount of the beauty component drastically increases as the temperature rises in a range of more than or equal to the boiling point of the beauty component. Note that, an upper limit of the range of more than or equal to the boiling point of the beauty component is a decomposition point of the beauty component.

Therefore, in a case where a small amount of beauty component is atomized, controller 9 controls the heating of heater 51 and controls the temperature of contactor 39, based on the temperature measured by thermocouple 53, in a first temperature target range of more than or equal to the melting point or sublimation point of the beauty component and less than or equal to the boiling point of the beauty component. Controller 9 controls the temperature of contactor 39 in the first temperature target range, and thus, the beauty component in component solid part 33 becomes a liquid, and deformation of component solid part 33 due to the atomization of the beauty component can be minimized. In addition, component solid part 33 can be efficiently consumed, and a replacement frequency of component solid part 33 can be reduced.

Controller 9 sets a reference target temperature such as an intermediate temperature between the melting point and the boiling point of the beauty component between the melting point and the boiling point in the first temperature target range. In a case where the atomization amount of the beauty component is increased, controller 9 controls the temperature of contactor 39 between the reference target temperature and the boiling point of the beauty component. In a case where the atomization amount of the beauty component is decreased, controller 9 adjusts the temperature of contactor 39 between the reference target temperature and the melting point of the beauty component. Controller 9 sets the reference target temperature of contactor 39, and thus, the optimum atomization amount of beauty component can be ejected from ejector 13.

In a case where a large amount of beauty component is atomized, controller 9 controls the heating of heater 51 and controls the temperature of contactor 39 based on the temperature measured by thermocouple 53 in a second temperature target range that is more than or equal to the boiling point of the beauty component. Controller 9 controls the temperature of contactor 39 in the second temperature target range, and thus, the beauty component in component solid part 33 becomes a gas. As a result, the beauty component is not dripped in component solid part 33. In addition, since the temperature of contactor 39 is more than or equal to the boiling point of the beauty component, the beauty component can be atomized in a short time.

Controller 9 detects that component solid part 33 and contactor 39 come into contact with each other from force detector 55, and controls the heating of heater 51 to change the temperature of contactor 39 based on the temperature measured by thermocouple 53 after a predetermined time has elapsed. In a case of increasing the atomization amount of the beauty component, controller 9 controls the heating of heater 51 to raise the temperature of contactor 39. On the other hand, in a case of decreasing the atomization amount of the beauty component, controller 9 controls the heating of heater 51 to lower the temperature of contactor 39. Controller 9 changes the temperature of contactor 39, and thus, the atomization amount of the beauty component can be stabilized.

For example, it is assumed that the pressing force of component solid part 33 is constant and that the atomization amount of the beauty component changes with respect to the target atomization amount as illustrated in FIG. 18. FIG. 23 is a graph representing a change in temperature of contactor 39 with respect to time in FIG. 18. As illustrated in FIG. 23, controller 9 controls the heating of heater 51 based on the temperature measured by thermocouple 53, and holds the temperature of contactor 39 at, for example, a high temperature near the boiling point until a predetermined time. After a predetermined time has elapsed, controller 9 controls the heating of heater 51 based on the temperature measured by thermocouple 53, and holds the temperature of contactor 39 at, for example, a low temperature near the melting point until a predetermined time.

For example, it is assumed that the pressing force of component solid part 33 is constant and that the atomization amount of the beauty component changes with respect to the target atomization amount as illustrated in FIG. 20. FIG. 24 is a graph representing the change in temperature of contactor 39 with respect to time in FIG. 20. As illustrated in FIG. 24, first, controller 9 sets a reference target temperature between the melting point and the boiling point of the beauty component. Subsequently, controller 9 controls the heating of heater 51 based on the temperature measured by thermocouple 53, and holds the temperature of contactor 39 at a temperature higher than the reference target temperature until a predetermined time. Subsequently, after a predetermined time has elapsed, controller 9 controls the heating of heater 51 based on the temperature measured by thermocouple 53, and holds the temperature of contactor 39 at a temperature lower than the reference target temperature until a predetermined time. Subsequently, after a predetermined time has elapsed, controller 9 controls heating of heater 51 based on the temperature measured by thermocouple 53, and holds the temperature of contactor 39 at a temperature higher than the reference target temperature until a predetermined time. Subsequently, after a predetermined time has elapsed, controller 9 controls the heating of heater 51 based on the temperature measured by thermocouple 53, and holds the temperature of contactor 39 at a temperature lower than the reference target temperature until a predetermined time. Subsequently, after a predetermined time has elapsed, controller 9 controls heating of heater 51 based on the temperature measured by thermocouple 53, and holds the temperature of contactor 39 at a temperature higher than the reference target temperature until a predetermined time. After a predetermined time has elapsed, controller 9 controls the heating of heater 51 based on the temperature measured by thermocouple 53, and holds the temperature of contactor 39 at the reference target temperature until a predetermined time.

When the temperature of contactor 39 is raised, controller 9 heats air blower heater 31 to set the airflow as warm air. On the other hand, when the temperature of contactor 39 is raised, controller 9 stops the heating of air blower heater 31 and sets the airflow as air at a normal temperature. A response speed to the change in atomization amount of the beauty component can be improved by assisting the temperature change of contactor 39 with warm air and air at a normal temperature.

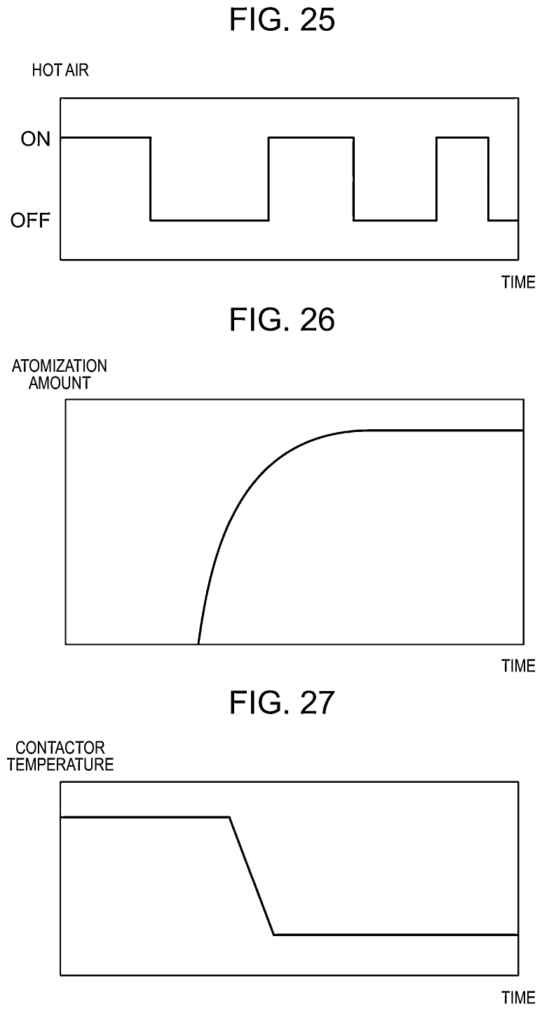

For example, it is assumed that contactor 39 changes in temperature as illustrated in FIG. 24. FIG. 25 is a graph representing a timing at which the air blower in FIG. 24 blows warm air. As illustrated in FIG. 25, controller 9 heats air blower heater 31 when the temperature of contactor 39 increases, and sets the airflow as warm air, and stops the heating of air blower heater 31 when the temperature of contactor 39 decreases, and sets the airflow as air at a normal temperature.

When component solid part 33 and contactor 39 are in a state of being separated from each other, that is, when component solid part 33 and contactor 39 are in a non-contact state, controller 9 heats heater 51 to preheat contactor 39 to be more than or equal to the melting point of the beauty component. Contactor 39 is preheated, and thus, the beauty component is immediately atomized when component solid part 33 and contactor 39 come into contact with each other. As a result, an atomization speed of the beauty component can be improved.

FIG. 26 is a graph representing the change in atomization amount of the beauty component with respect to time. For example, it is assumed that the atomization amount of the beauty component is changed as illustrated in FIG. 26 from when component solid part 33 and contactor 39 come into contact with each other. Note that, the pressing force of component solid part 33 is constant. FIG. 27 is a graph representing the change in temperature of contactor 39 with respect to time in FIG. 26. As illustrated in FIG. 27, controller 9 controls the heating of heater 51 based on the temperature measured by thermocouple 53 in a state where component solid part 33 and contactor 39 are separated from each other, and holds the temperature of contactor 39 at, for example, a high temperature near the boiling point until a predetermined time. Subsequently, controller 9 detects that component solid part 33 and contactor 39 come into contact with each other from force detector 55. After a predetermined time has elapsed from when component solid part 33 and contactor 39 come into contact with each other, controller 9 controls the heating of heater 51 based on the temperature measured by thermocouple 53 and holds the temperature of contactor 39 at, for example, a low temperature near the melting point until a predetermined time.

Controller 9 simultaneously controls the pressing force of component solid part 33 and the temperature of contactor 39 to correspond to the atomization amount of the beauty component. In a case where the atomization amount of the beauty component is increased, controller 9 operates driver 37 to increase the pressing force of component solid part 33, and heats heater 51 to raise the temperature of contactor 39. On the other hand, in a case of decreasing the atomization amount of the beauty component, controller 9 operates driver 37 to decrease the pressing force of component solid part 33, and suppress the heating of heater 51 to lower the temperature of contactor 39. In addition, in a case where the atomization of the beauty component is finished, controller 9 operates driver 37 to separate component solid part 33 from contactor 39, stops the heating of heater 51, and lowers the temperature of contactor 39. Controller 9 simultaneously controls the pressing force of component solid part 33 and the temperature of contactor 39, and thus, the optimum atomization amount beauty component can be further ejected from ejector 13. In addition, the response speed to the change in atomization amount of the beauty component can be further improved.

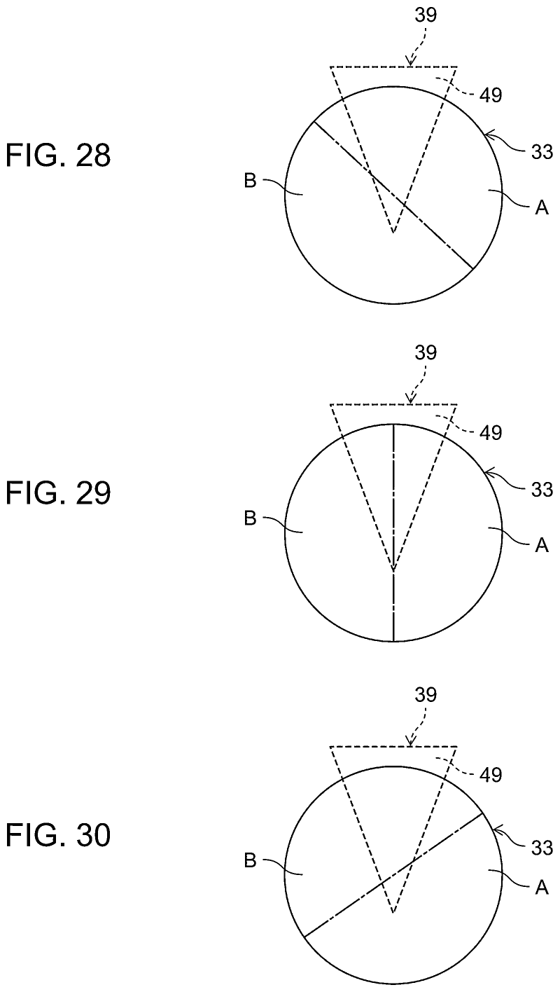

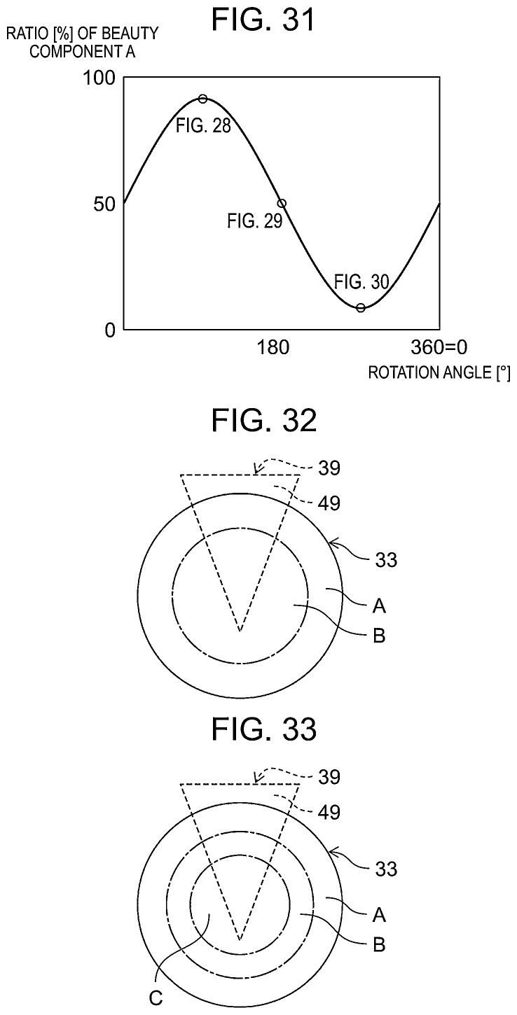

Here, component solid part 33 may contain a plurality of kinds of beauty components. FIG. 28 is a front view when component solid part 33 of beauty component atomizer 1 according to the present exemplary embodiment contains the plurality of kinds of beauty components. FIG. 29 is a side view when component solid part 33 rotates from the state of FIG. 28. FIG. 30 is a side view when component solid part 33 rotates from the state of FIG. 29. FIG. 31 is a graph representing a change in ratio of beauty component A in the atomized beauty component with respect to a rotation angle of the component solid part illustrated in FIGS. 28 to 30. FIG. 32 is a front view illustrating an example of disposition of beauty components when component solid part 33 of beauty component atomizer 1 according to the present exemplary embodiment contains the plurality of kinds of beauty components. FIG. 33 is a front view illustrating another example of the disposition of the beauty components when component solid part 33 of beauty component atomizer 1 according to the present exemplary embodiment contains the plurality of kinds of beauty components. For example, as illustrated in FIGS. 28 to 30, component solid part 33 contains beauty component A and beauty component B. Beauty component A and beauty component B are contained in symmetrical shapes about a circumferential direction of component solid part 33. Contact part 49 of contactor 39 is disposed at a position where vertexes of the triangular shape deviate from a center of component solid part 33. Note that, here, beauty component A and beauty component B can be simultaneously atomized. In a case where beauty component A and beauty component B can be independently atomized, the vertexes of the triangular shape of contact part 49 may be disposed to correspond to the center of component solid part 33. Note that, the plurality of kinds of beauty components are not limited to two kinds, and may be three or more kinds. When there are three or more kinds of beauty components, a plurality of kinds of beauty components are contained in component solid part 33 such that the plurality of kinds of beauty components can be divided in a radial direction from a central part of component solid part 33.

In such a component solid part 33, in a case where a large amount of beauty component A is atomized, for example, as illustrated in FIG. 28, controller 9 operates driver 37 to rotate component solid part 33 and to bring most of contact part 49 of contactor 39 into contact with beauty component A. In a case where beauty component A and beauty component B are equally atomized, as illustrated in FIG. 29, controller 9 operates driver 37 to rotate component solid part 33, and to equally bring contact part 49 of contactor 39 into contact with beauty component A and beauty component B. In a case where a large amount of beauty component B is atomized, for example, as illustrated in FIG. 30, controller 9 operates driver 37 to rotate component solid part 33 and to bring most of contact part 49 of contactor 39 into contact with beauty component B. FIG. 31 illustrates a change in ratio of beauty component A in the atomized beauty component with respect to the rotation of component solid part 33.

Component solid part 33 contains the plurality of kinds of beauty components, and thus, component solid part 33 is brought into contact with contactor 39. As a result, the plurality of kinds of beauty components can be atomized. In addition, controller 9 controls the operation of driver 37 to change a rotational position of component solid part 33, and thus, atomization ratios between the plurality of kinds of beauty components can be changed.

Note that, beauty component A and beauty component B may be disposed such that beauty component B is continuously disposed in a circumferential direction on an inner side and beauty component A is continuously disposed in a circumferential direction on an outer side with respect to component solid part 33, for example, as illustrated in FIG. 32. In such disposition, component solid part 33 may contain three or more kinds of beauty components. For example, as illustrated in FIG. 33, beauty component C may be disposed continuously in a circumferential direction on the inner side of component solid part 33, beauty component B may be disposed continuously in the circumferential direction on the outer side of beauty component C, and beauty component A may be disposed continuously in the circumferential direction on the outer side of beauty component B.

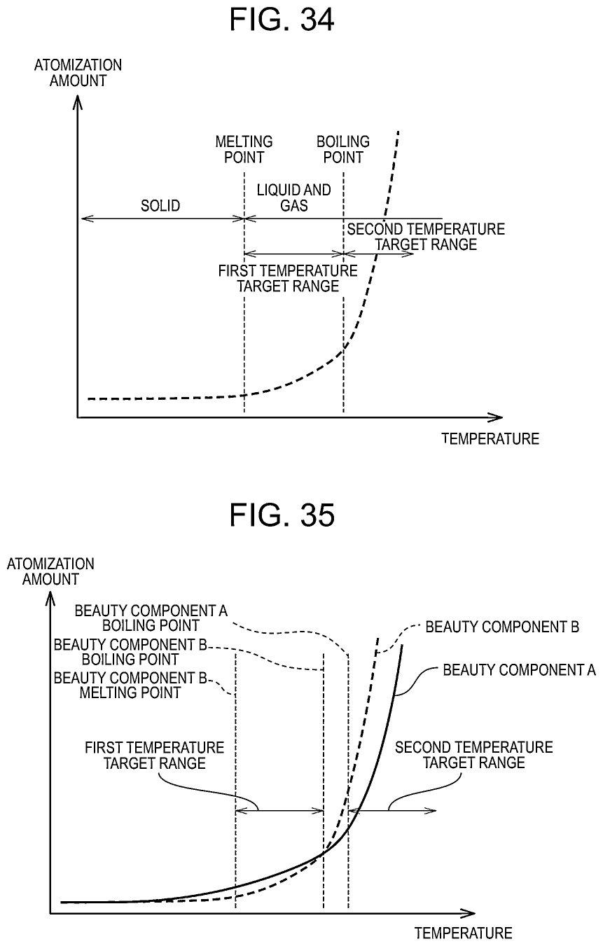

The plurality of kinds of beauty components of component solid part 33 may have different melting points and boiling points from each other. For example, the beauty component having the change in atomization amount with respect to the temperature illustrated in FIG. 22 is defined as beauty component A. FIG. 34 is a graph representing a change in atomization amount of beauty component B with respect to the temperature. FIG. 35 is a graph representing changes in atomization amount of beauty component A and beauty component B with respect to a temperature. The beauty component having the change in atomization amount with respect to the temperature illustrated in FIG. 34 is defined as beauty component B. A melting point of beauty component B is higher than a melting point of beauty component A. A boiling point of beauty component A is higher than a boiling point of beauty component B. Thus, as illustrated in FIG. 35, a first temperature target range when beauty component A and beauty component B are atomized in a small amount is set in a range of more than or equal to the melting point of the beauty component B and less than or equal to the boiling point of the beauty component B. On the other hand, a second temperature target range when beauty component A and beauty component B are atomized in a large amount is set in a range of more than or equal to the boiling point of the beauty component A.

In a case where a small amount of beauty component A and beauty component B are atomized, based on the temperature measured by thermocouple 53, controller 9 controls the heating of heater 51 to control the temperature of contactor 39 in the first temperature target range. Controller 9 controls the temperature of contactor 39 in the first temperature target range, and thus, beauty component A and beauty component B in component solid part 33 become liquid. As a result, deformation of component solid part 33 due to the atomization of beauty component A and beauty component B can be minimized. In addition, component solid part 33 can be efficiently consumed, and a replacement frequency of component solid part 33 can be reduced.

In the first temperature target range, controller 9 sets a reference target temperature such as an intermediate temperature between the melting point and the boiling point of beauty component B between the melting point and the boiling point of beauty component B. In a case where the atomization amount of beauty component A and beauty component B is increased, controller 9 controls the temperature of contactor 39 between the reference target temperature and the boiling point of beauty component B. In a case where the atomization amount of beauty component A and beauty component B is decreased, controller 9 adjusts the temperature of contactor 39 between the reference target temperature and the melting point of beauty component B. Controller 9 sets the reference target temperature of contactor 39, and thus, optimum atomization amounts of beauty component A and beauty component B can be ejected from ejector 13.

In a case where a large amount of beauty component A and beauty component B are atomized, based on the temperature measured by thermocouple 53, controller 9 controls the heating of heater 51 to control the temperature of contactor 39 in the second temperature target range. Controller 9 controls the temperature of contactor 39 in the second temperature target range, and thus, beauty component A and beauty component B in component solid part 33 become gases. As a result, beauty component A and beauty component B are not dripped in component solid part 33. In addition, since the temperature of contactor 39 is more than or equal to the boiling point of beauty component A which is more than the boiling point of beauty component B, beauty component A and beauty component B can be atomized in a short time.

Note that, even in a case where three or more kinds of beauty components having different melting points and boiling points are contained in component solid part 33, controller 9 similarly sets a first temperature target range, a reference target temperature, and ae second temperature target range, and performs similar control.

Here, in a case where a plurality of kinds of beauty components having different melting points are disposed in component solid part 33 as illustrated in FIGS. 32 and 33, a beauty component having a high melting point is disposed inside and a beauty component having a low melting point is disposed outside. In component solid part 33 illustrated in FIG. 32, since the melting point of beauty component B is higher than beauty component A, beauty component B is disposed on the inner side, and beauty component A is disposed on the outer side. In component solid part 33 illustrated in FIG. 33, the melting point of beauty component C is higher than the melting points of beauty component A and beauty component B. Beauty component C is disposed inside. Beauty component B is disposed outside of beauty component C. Beauty component A is disposed outside of beauty component B.

For example, in component solid part 33 illustrated in FIG. 32, in a case where only beauty component A is atomized, controller 9 controls the heating of heater 51 based on the temperature measured by thermocouple 53, and sets the temperature of contactor 39 to be more than or equal to the melting point of beauty component A and less than the melting point of beauty component B. Controller 9 operates driver 37 to bring component solid part 33 into contact with contactor 39, and to atomize only beauty component A. In component solid part 33, even though only beauty component A is atomized, beauty component B on a central part side remains. Thus, hollowing of component solid part 33 can be prevented, and deformation of component solid part 33 can be minimized. In addition, even in a case where the temperature of contactor 39 is more than or equal to the melting point of beauty component B, since the atomization amount of beauty component A is larger, the deformation of component solid part 33 can be minimized. Note that, even in component solid part 33 containing three or more kinds of beauty components as illustrated in FIG. 33, controller 9 similarly controls the temperature of contactor 39, and thus, the deformation of component solid part 33 can be minimized. As described above, in component solid part 33 containing the plurality of kinds of beauty components, the beauty component having the low melting point is disposed on the outer side, and thus, the deformation of component solid part 33 can be minimized.

Here, in a case where driver 37 has a mechanism for independently changing the pressing force of component solid part 33 and the rotation of component solid part 33, controller 9 controls each mechanism. In a case where component solid part 33 contains one kind of beauty component, controller 9 operates driver 37 to rotate component solid part 33, and performs control such that contactor 39 uniformly comes into contact in the circumferential direction of component solid part 33. Component solid part 33 is rotated to bring the contactor 39 into uniform contact with each other, and thus, the beauty component can be atomized uniformly in the circumferential direction of component solid part 33. As a result, component solid part 33 can be consumed without waste. Component solid part 33 is consumed without waste, and thus, the replacement frequency of component solid part 33 can be reduced.

On the other hand, in a case where component solid part 33 contains the plurality of kinds of beauty components, it is assumed that the beauty components are disposed in component solid part 33 as illustrated in FIGS. 28 to 30. In this case, controller 9 controls the operation of driver 37 to stop the rotation of component solid part 33 at the same position and to change the pressing force of component solid part 33. Thus, the atomization ratios between the plurality of kinds of beauty components can be set to be constant, and the atomization amount can be changed.

Here, in a case where component solid part 33 contains the plurality of kinds of beauty components, a kind detector (not illustrated) that discriminates the kind of the beauty component may be provided for contactor 39. The kind detector is provided in contact part 49 of contactor 39, for example, and is electrically connected to controller 9. The kind detector inputs the kind of the beauty component contained in component solid part 33 to controller 9.

Based on the kind of the beauty component detected by the kind detector, controller 9 controls the operation of driver 37 to control the pressing force of component solid part 33. Thus, the control of the pressing force of component solid part 33 corresponding to the characteristics of the beauty component contained in component solid part 33 can be performed, and different kinds of beauty components can be appropriately atomized.

In addition, controller 9 controls overheating of heater 51 to control the temperature of contactor 39 based on the kind of the beauty component detected by the kind detector. Thus, it is possible to control the temperature of contactor 39 corresponding to the melting point or boiling point (or sublimation point) specific to the beauty component contained in component solid part 33, and it is possible to appropriately atomize the different kinds of beauty components. Note that, controller 9 simultaneously controls the pressing force of component solid part 33 and the temperature of contactor 39 based on the kind of the beauty component detected by the kind detector.

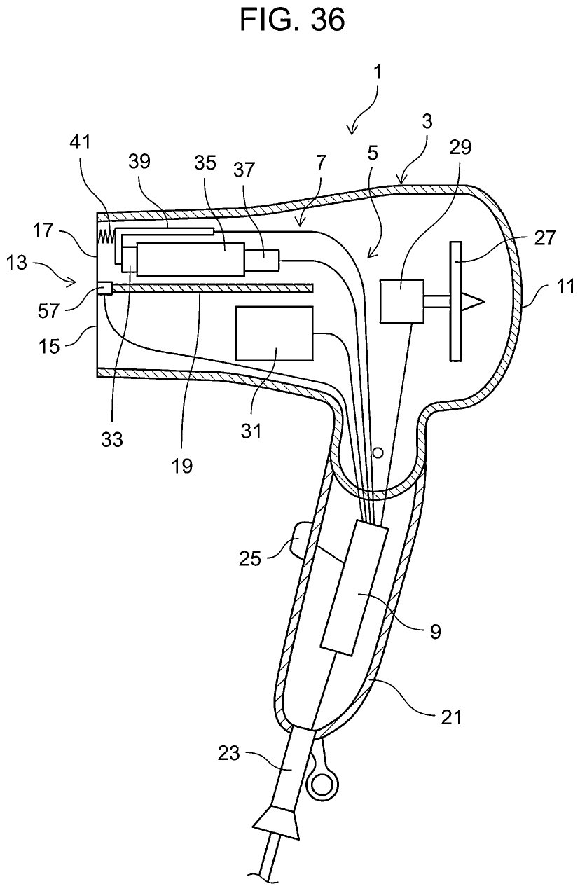

FIG. 36 is a cross-sectional view when the beauty component atomizer according to the present exemplary embodiment includes an atomization amount detector. As illustrated in FIG. 36, beauty component atomizer 1 may include atomization amount detector 57 that measures the atomization amount of the atomized beauty component. Atomization amount detector 57 is disposed, for example, near component ejection port 17 of ejector 13. Atomization amount detector 57 is electrically connected to controller 9. Atomization amount detector 57 measures the atomization amount of the atomized beauty component contained in the airflow ejected from ejector 13, and inputs the atomization amount to controller 9.

Based on the atomization amount measured by atomization amount detector 57, controller 9 controls the operation of driver 37 to control the pressing force of component solid part 33, and controls the heating of heater 51 to control the temperature of contactor 39. Controller 9 controls the operation of driver 37 and the temperature of contactor 39 based on the atomization amount measured by atomization amount detector 57, and thus, the optimum atomization amount of beauty component can be ejected from ejector 13. In addition, it is not necessary to set a target atomization amount to be predicted, and controller 9 can perform accurate control corresponding to the atomization amount on contactor 39 and driver 37.

Beauty component atomizer 1 includes component solid part 33 containing at least one kind of beauty component that is solid or quasi-solid at a normal temperature, and heatable contactor 39. In addition, the beauty component atomizer further includes driver 37 that is connected to one of component solid part 33 and contactor 39 to move the one with respect to the other, and controller 9 that is electrically connected to contactor 39 and driver 37 to control the temperature of contactor 39 and the operation of driver 37. Controller 9 sets the temperature of contactor 39 to be more than or equal to the melting point or sublimation point of the beauty component, operates driver 37 to change the contact state between component solid part 33 and contactor 39 while continuously bringing component solid part 33 and contactor 39 into contact with each other, and atomizes the beauty component.

Controller 9 brings component solid part 33 containing the beauty component that is solid or quasi-solid at a normal temperature into contact with contactor 39 heated to be more than or equal to the melting point or sublimation point of the beauty component, and atomizes the beauty component. Thus, until the beauty component of component solid part 33 is completely atomized, the atomization amount of the beauty component does not change, and a spray amount of the beauty component can be stabilized.

In addition, controller 9 atomizes the beauty component while continuously bringing component solid part 33 and contactor 39 into contact with each other. Thus, the beauty component is continuously atomized without interruption. Further, controller 9 changes the contact state between component solid part 33 and contactor 39, and atomizes the beauty component. Thus, the atomization amount of the beauty component can be adjusted by changing the contact state between component solid part 33 and contactor 39.

Accordingly, in beauty component atomizer 1, the spray amount of the beauty component can be stabilized.

In addition, in a case where the atomization amount of the beauty component is increased, controller 9 operates driver 37 to raise the pressing force between component solid part 33 and contactor 39. Further, in a case where the atomization amount of the beauty component is decreased, controller 9 operates driver 37 to lower the pressing force between component solid part 33 and contactor 39. Thus, controller 9 can adjust the atomization amount of beauty component by controlling the pressing force between component solid part 33 and contactor 39.

In addition, elastic member 41 that is elastically deformed and receives a pressing force from one of component solid part 33 and contactor 39 when component solid part 33 and contactor 39 come into contact with each other abuts on the other of component solid part 33 and contactor 39. Thus, the variation in contact pressure between component solid part 33 and the contactor 39 can be suppressed, and the variation in atomization amount of the beauty component can be suppressed.

In addition, beauty component atomizer 1 includes force detector 55 that measures the pressing force when component solid part 33 and contactor 39 come into contact with each other, and is electrically connected to controller 9. Based on the pressing force measured by force detector 55, controller 9 operates driver 37 to change the contact state between component solid part 33 and contactor 39. Thus, controller 9 controls the operation of driver 37 based on the pressing force measured by force detector 55, and thus, an optimum pressing force corresponding to the atomization amount can be obtained.

In addition, after a predetermined time has elapsed from when component solid part 33 and contactor 39 come into contact with each other, controller 9 operates driver 37 to change the contact state between component solid part 33 and contactor 39 and to change the temperature of contactor 39. Thus, a predetermined amount of beauty component can be atomized, and the atomization amount of the beauty component can be stabilized.

In addition, when component solid part 33 and contactor 39 are separated from each other, controller 9 preheats contactor 39. Thus, when component solid part 33 and contactor 39 come into contact with each other, the beauty component is immediately atomized, and the atomization speed of the beauty component can be improved.

In addition, controller 9 sets the reference target temperature of contactor 39 between the melting point and the boiling point of the beauty component. In a case where the atomization amount of the beauty component is increased, controller 9 controls the temperature of contactor 39 to be more than or equal to the reference target temperature and less than or equal to the boiling point of the beauty component. In addition, in a case where the atomization amount of the beauty component is decreased, controller 9 controls the temperature of contactor 39 to be more than or equal to the melting point of the beauty component and less than or equal to the reference target temperature. Thus, the reference target temperature of contactor 39 is set between the melting point and the boiling point of the beauty component by controller 9, and thus, the deformation of component solid part 33 due to the atomization of the beauty component can be minimized. In addition, component solid part 33 can be efficiently consumed, and a replacement frequency of component solid part 33 can be reduced. Further, an optimum amount of beauty component can be atomized.

In addition, when controller 9 sets the reference target temperature of contactor 39 and increases the atomization amount of the beauty component, controller 9 operates driver 37 to raise the pressing force between component solid part 33 and contactor 39. Further, when the reference target temperature of contactor 39 is set, in a case where the atomization amount of the beauty component is decreased, controller 9 operates driver 37 to lower the pressing force between component solid part 33 and contactor 39. Thus, controller 9 simultaneously controls the temperature of contactor 39 and the pressing force between component solid part 33 and contactor 39, and thus, the optimum amount of beauty component can be atomized.

In addition, controller 9 operates driver 37 such that the temperature of contactor 39 is held at a temperature of more than or equal to the boiling point of the beauty component and the pressing force between component solid part 33 and contactor 39 continues to act. Thus, the atomization speed of the beauty component can be improved, and the atomization amount of the beauty component can be continuously increased. In addition, the beauty component becomes the gas, and the beauty component is not dripped in component solid part 33.

In addition, component solid part 33 contains the plurality of kinds of beauty components. Thus, one component solid part 33 can atomize the plurality of kinds of beauty components.

In addition, the plurality of kinds of beauty components have different melting points. Thus, it is possible to select the beauty component to be atomized by changing the temperature of contactor 39.

In addition, beauty component atomizer 1 includes atomization amount detector 57 that measures the atomization amount of the atomized beauty component and is electrically connected to controller 9. Controller 9 controls the temperature of contactor 39 and the operation of driver 37 based on the atomization amount measured by atomization amount detector 57. Thus, the optimum amount of beauty component can be atomized. In addition, controller 9 can accurately control the temperature of contactor 39 and the operation of driver 37 to correspond to the atomization amount of the beauty component.

In addition, beauty component atomizer 1 includes air blower 5 that applies warm air and air at a normal temperature to the beauty component atomized via contactor 39, and is electrically connected to controller 9. Controller 9 causes air blower 5 to blow warm air when the temperature of contactor 39 is raised, and causes air blower 5 to blow air at a normal temperature when the temperature of contactor 39 is lowered. Thus, the temperature change of contactor 39 can be assisted by air blower 5, and the response speed to the change in atomization amount of the beauty component can be improved.

Note that, since the above exemplary embodiment is for illustrating the technique in the present disclosure, various modifications, replacements, additions, omissions, and the like, can be made within the scope of the claims or equivalents thereof.

For example, in the present exemplary embodiment, the driver is connected to the component solid part, but the present disclosure is not limited thereto, and the driver may be connected to the contactor.

In addition, although the component solid part is held by the holder, the present disclosure is not limited thereto, and a cover that covers the component solid part may be simply disposed around the component solid part. A region around the component solid part is covered, and thus, breakage of the component solid part at the time of falling can be suppressed.

### INDUSTRIAL APPLICABILITY

The present disclosure is applicable to a beauty component atomizer that ejects an atomized beauty component. Specifically, the present disclosure is applicable to a hair dryer, a straight iron, a curl iron, a facial treatment device, a scalp care device, a nail care device, and the like.

### REFERENCE MARKS IN THE DRAWINGS

1: beauty component atomizer
3: housing
5: air blower
7: atomizer
9: controller
11: suction port
13: ejector
15: ejection port
17: component ejection port
19: partition wall
21: grip
23: power supply unit
25: switch
27: fan
29: fan motor
31: air blower heater
33: component solid part
35: holder
37: driver
39: contactor
41: elastic member
43: screw
45: guide
47: fixing part
49: contact part
51: heater
53: thermocouple
55: force detector
57: atomization amount detector
A, B, C: beauty component

1. A beauty component atomizer comprising:
a component solid part that contains at least one kind of beauty component that is solid or quasi-solid at a normal temperature;
a contactor which is heatable;
a driver that is connected to at least one selected from the group consisting of the component solid part and the contactor, and is configured to change a physical distance between the component solid part and the contactor; and
a controller that is electrically connected to the contactor and the driver to control a temperature of the contactor and an operation of the driver,
wherein
the controller
sets the temperature of the contactor to be more than or equal to a melting point or sublimation point of the beauty component,
operates the driver to change a contact state between the component solid part and the contactor while continuously bringing the component solid part and the contactor into contact with each other, and
atomizes the beauty component.

2. The beauty component atomizer according to claim 1, wherein
the controller operates the driver in such a way that a pressing force between the component solid part and the contactor is raised in a case where an atomization amount of the beauty component is increased and that the pressing force between the component solid part and the contactor is lowered in a case where the atomization amount of the beauty component is decreased.

3. The beauty component atomizer according to claim 1, further comprising:
an elastic member that is elastically deformed when the component solid part and the contactor comes into contact with each other.

4. The beauty component atomizer according to claim 1, further comprising:
a force detector that measures a pressing force when the component solid part and the contactor comes into contact with each other, and is electrically connected to the controller,
wherein
the controller operates the driver based on the pressing force measured by the force detector, and changes the contact state between the component solid part and the contactor.

5. The beauty component atomizer according to claim 1, wherein, after a predetermined time has elapsed from when the component solid part and the contactor comes into contact with each other, the controller operates the driver to change the contact state between the component solid part and the contactor, and changes the temperature of the contactor.

6. The beauty component atomizer according to claim 1, wherein the controller preheats the contactor when the component solid part and the contactor are separated from each other.

7. The beauty component atomizer according to claim 1, wherein
the controller sets a reference target temperature of the contactor between the melting point and a boiling point of the beauty component,
the controller controls the temperature of the contactor to be more than or equal to the reference target temperature and less than or equal to the boiling point of the beauty component in a case where an atomization amount of the beauty component is increased, and
the controller controls the temperature of the contactor to be more than or equal to the melting point of the beauty component and less than or equal to the reference target temperature in a case where the atomization amount of the beauty component is decreased.

8. The beauty component atomizer according to claim 1, wherein
the controller operates the driver in such a way that the temperature of the contactor is held at a temperature of more than or equal to boiling point of the beauty component, and that the pressing force between the component solid part and the contactor continues to act.

9. The beauty component atomizer according to claim 1, wherein
the at least one kind of beauty component includes a plurality of kinds of beauty components, and
the plurality of kinds of beauty components are contained in the component solid part.

10. The beauty component atomizer according to claim 9, wherein
the plurality of kinds of beauty components have melting points different from each other.

11. The beauty component atomizer according to claim 1, further comprising:
an atomization amount detector that measures an atomization amount of the atomized beauty component, and is electrically connected to the controller,
wherein
the controller controls the temperature of the contactor and the operation of the driver based on the atomization amount measured by the atomization amount detector.

12. The beauty component atomizer according to claim 1, further comprising:
an air blower that applies warm air and air at a normal temperature to the beauty component atomized via the contactor, and is electrically connected to the controller,
wherein
the controller blows the warm air from the air blower when the temperature of the contactor is raised, and blows the air at the normal temperature from the air blower when the temperature of the contactor is lowered.
